(19) United States
(12) Patent Application Publication
(10) Pub. No.: US 2015/0127363 A1
(43) Pub. Date: May 7, 2015

(54) METHOD AND A SYSTEM FOR FACILITATING A USER TO AVAIL EYE-CARE SERVICES OVER A COMMUNICATION NETWORK

(71) Applicants: Omondi Nyong'o, Dublin, CA (US); Nisim Levy, Los Gatos, CA (US); Jason Arnold Villanueva Cuenco, Bay Point, CA (US); Alon Konchitsky, Santa Clara, CA (US)

(72) Inventors: Omondi Nyong'o, Dublin, CA (US); Nisim Levy, Los Gatos, CA (US); Jason Arnold Villanueva Cuenco, Bay Point, CA (US); Alon Konchitsky, Santa Clara, CA (US)

(73) Assignee: WEST COAST VISION LABS INC., Dublin, CA (US)

(21) Appl. No.: 14/525,505

(22) Filed: Oct. 28, 2014

Related U.S. Application Data
(60) Provisional application No. 61/898,903, filed on Nov. 1, 2013.

(51) Int. Cl. G06F 19/00; G06Q 50/00

(52) U.S. Cl. CPC G06F 19/3418; G06Q 50/01; G06F 19/3487; G06F 19/3437
USPC 705/2

(57) ABSTRACT

Embodiments disclosed herein provide a system and a method for facilitating a user to access an eye-care service application module to avail eye-care services from one or more eye-care service providers over a communication network. In one embodiment, the user access the eye-care service application module to record and send user data, such as, scanned data of head and eyes of the user. User receives health-reports from the one or more eye-care service providers based on the user data. One or more child health care service providers involved in eye-care services may also send/receive the health-reports to/from other child health care providers involved in eye-care services. A blue print of a custom-fit eye-wear for the user may be generated based on the scanned data. User may create and share one or more online avatars of the user and his/her friends connected in a social networking environment.

### RELATED PATENT APPLICATION AND INCORPORATION BY REFERENCE

This is a utility application based upon U.S. patent application Ser. No. 61/898,903 filed on or about Nov. 1, 2013. This related application is incorporated herein by reference and made a part of this application. If any conflict arises between the disclosure of the invention in this utility application and that in the related provisional application, the disclosure in this utility application shall govern. Moreover, the inventor(s) incorporate herein by reference any and all patents, patent applications, and other documents hard copy or electronic, cited or referred to in this application.

### FIELD OF THE INVENTION

This invention relates generally to health care service systems and methods, and more specifically to a system and a method for providing eye care facility to users over a communication network.

### BACKGROUND

The sense of sight in human beings is critical for gathering information from the environment. Eighty percent of our brain structure is involved in processing vision and approximately thirty percent of our brain by mass is exclusively reserved for the processing of vision. We learn about our environment and world best through good vision at an early age and throughout childhood development. Impaired vision is detrimental to health as it limits a wide range of sight-dependent activities, reduces quality of life, increases risk of other physical morbidity, restricts physical participation in our environment and impairs social interaction with other human beings. In addition, impaired vision reduces academic and educational potential in children and adults. Normal eyesight is necessary for an individual to acquire accurate visual information thereby obviating or mitigating the detrimental effects in all spheres mentioned above.

The recognition of the importance of having normal vision from an early age in life is the basis for protocol assessments (or screenings) of children for potential deficits in their vision. This is done in the medical home by a health care worker, or otherwise is done in school by a layperson or school-based health care worker. The medical home is a system with caregivers that provide health and wellbeing for a child and his or her family. Typically, a primary care physician is a central coordinating team member of a medical home. Out of these screening assessments, from between 10% and 25% children are found to ultimately require prescription eyeglasses in order to attain normal vision and in order to reach their full sight-based developmental potential. Most children who require eyeglasses have ‘garden variety’ refractive errors such as myopia, astigmatism, or hyperopia. These conditions cause functional deficits that are easily correctable. A minority but significant group of other children has a medically based visual disorder such as unequal refractive errors, amblyopia (otherwise known as ‘lazy eye’), strabismus or structural occlusion or preclusion of the axis of sight. The prescription of specially purposed eyeglasses forms a pillar in the successful treatment of almost all of these children. However, treatment effects are diminished if eyeglass frames do not fit properly and if eyeglasses slide off the nose, face or head of a child.

Furthermore, children have underdeveloped facial structure with various immature facial features. Therefore, a ‘one-size-fits-all’ approach to eyewear does not work well with children. Pediatric ophthalmologists, optometrists, other health care providers, teachers and parents notoriously must deal with children who are constantly uncomfortable with their eyeglasses in part because their eyeglasses do not adequately and comfortably fit them. The eyeglass frames worn by children can be uncomfortable and misaligned on their face. They can be easily dropped, broken, bent, chewed or turned into reverse (vis-à-vis the lenses) by children. As a result children suffer needlessly. They do not receive the safe, constant, comfortable vision correction and treatment that they need. Some affected children end up missing a one-time window of opportunity to learn to see and instead end up with permanent low vision, all because they did not receive a properly fitting pair of eyeglasses.

Therefore, it is a functional and medical requirement that eyeglass frames for children be designed and dispensed accurately and appropriately. The frames should correctly fit on the particular face of each child so that the child can enjoy proper vision and receive a superior standard of vision correction and treatment. Children may receive enhanced and more efficient treatment if the treatment service is available via the medium of the Internet and its attendant communication network. Internet-based information technology facilitates the availing of health related services by permitting health care consumers to communicate with health care providers, to view available products and services, to apply for products and/or to receive consultative advice from health care service providers.

In light of the above discussion, there is a need in the art to provide a novel method and system for providing eye-care services and custom-fit eyeglasses over a communication network. This novel method and system is needed not only for children but also for adults. This is because children naturally grow into adults and a novel method and system similarly must be able to naturally adjust to meet the changing anatomic, visual and lifestyle needs of a human being as they change from a child to an adult. A novel method and system is also needed for both children and adults because adults care for children and are the arbiters of child consumer decision making, especially as germane to health care and health care product decision-making in conjunction with health care providers.

### SUMMARY

In accordance with the above, it is an object of the present invention to provide a solution to attain proper fit for eyewear and other personal artifacts worn by users. Another object of the present invention is to provide customized design, customized manufacturing, and correlative distribution of eyeglasses and eyewear frames. Yet another object of the present invention is to provide a solution for providing health care services relating to eye care to users via various communication networks. Yet another object of the present invention is to provide an online system and method for facilitating a user, the user being a child and/or an adult, to avail eye-care services from one or more eye-care service providers over a communication network.

In one embodiment herein, an application server is configured for storing an eye-care service application module One or more communication devices, each having a web-based user interface may be configured to: (i) facilitate the user to access the eye-care service application module to record and send user data to the one or more eye-care service providers, (ii) facilitate the user to receive health-reports from the one or more eye-care service providers based on the user data, and (iii) facilitate one or more child health care service providers involved in eye-care services to send/receive the health-reports to/from other child health care providers involved in eye-care services.

Further, a repository/database is configured to securely store the user data and the health-reports. The eye-care application module comprises a receiving module configured to obtain the user data including but not limiting to scanned data of head and eyes of the user. The user data further includes vision measurements of the user and virtual trial-fits data that are processed to develop a blue print of the custom-fit eyewear for the user.

A processing module is also configured to: (i) analyze the scanned data to generate the blue print of a custom-fit eye-wear for the user, and (iii) process the user data to generate the report.

Furthermore, an avatar creation module configured to facilitate the user to create and share one or more online avatars of the user and his/her friends connected in a social networking environment.

In one embodiment of the invention, the trial-fits data are recorded by the user and/or the eye-care service providers by taking virtual trials of the eyewear while accessing the eye-care application module. The eye-care application module is further configured to provide various mathematical and processing algorithms to generate a plurality of options for the custom-fit eyewear, wherein the options include cost, color, design, lens type, and manufacturing materials of the custom-fit eyewear for selection and preferences of the user. The blue print may be outputted for 3D printing, modeling and fabrication of the custom-fit eyewear.

In one embodiment of the present invention, a method for facilitating a user to avail eye-care services from one or more eye-care service providers over a communication network. The method comprising the steps of: configuring one or more communication devices, each having a web-based user interface for: (i) facilitating the user to access the eye-care service application module to record and send user data to the one or more eye-care service providers, (ii) facilitating the user to receive health-reports from the one or more eye-care service providers based on the user data, and (iii) facilitating one or more child health care service providers involved in eye-care services to send/receive the health-reports to/from other child health care providers involved in eye-care services.

The method further comprises the steps of securely storing in a repository/database the user data and the health-reports; storing and configuring the eye-care application module in an application server to: (i) obtain the user data including but not limiting to scanned data of head and eyes of the user, (ii) analyze the scanned data to generate a blue print of a custom-fit eye-wear for the user, and (iii) process the user data to generate the report. Further, an avatar creation module may be configured for creating and sharing one or more online avatars of the user and his/her friends connected in a social networking environment.

Other features and advantages of the present invention will be more apparent in the description provided in this specification along with the figures.

### BRIEF DESCRIPTION OF THE DRAWINGS

Reference will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIGS. 1a and 1b, respectively, illustrate a block diagram of the system and the eye-care application module for facilitating a user to avail eye-care services over a communication network, according to one embodiment of the invention;

FIG. 2 illustrates scanned image of head of a user and uniform polygon mesh generation based on the scanned image, according to one embodiment of the invention;

FIG. 3 illustrates landmarks identification on the scanned image, according to one embodiment of the invention;

FIGS. 4A to 4C illustrate custom-fit eye wear, according to one embodiment of the invention;

FIGS. 5A and 5B illustrate alignment and alteration of frame geometry template based on the landmarks, according to one embodiment of the invention;

FIG. 6 is a flowchart illustrating a method for facilitating a user to avail eye-care services over a communication network, according to one embodiment of the invention; and

FIG. 7 illustrates an example computing system that can be used to implement the custom eyewear system disclosed herein.

Like reference numerals refer to like parts throughout the description of several views of the drawings.

### DETAILED DESCRIPTION OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout. Unless otherwise noted in this specification or in the claims, all of the terms used in the specification and the claims will have the meanings normally ascribed to these terms by workers in the art.

The present invention provides a novel and unique solution to provide a system and a method for generating custom-fit eyewear frame geometry that can be used for custom-fit eyewear frame modeling, fabrication and printing. While the present invention has applicability to at least the eyewear frames, the principles of the present invention are particularly applicable to all types of personal artifacts worn by adults and children, and all types of wearable healthcare devices, as well as other wearable devices that are required to be custom fit. For simplicity, the following description employ the terms ‘eyewear frames’, ‘glasses’ etcetera as an umbrella term to describe the embodiments of the present invention, but those skilled in the art will appreciate that the use of such term is not to be considered limiting to the scope of the invention, which is set forth by the claims appearing at the end of this description.

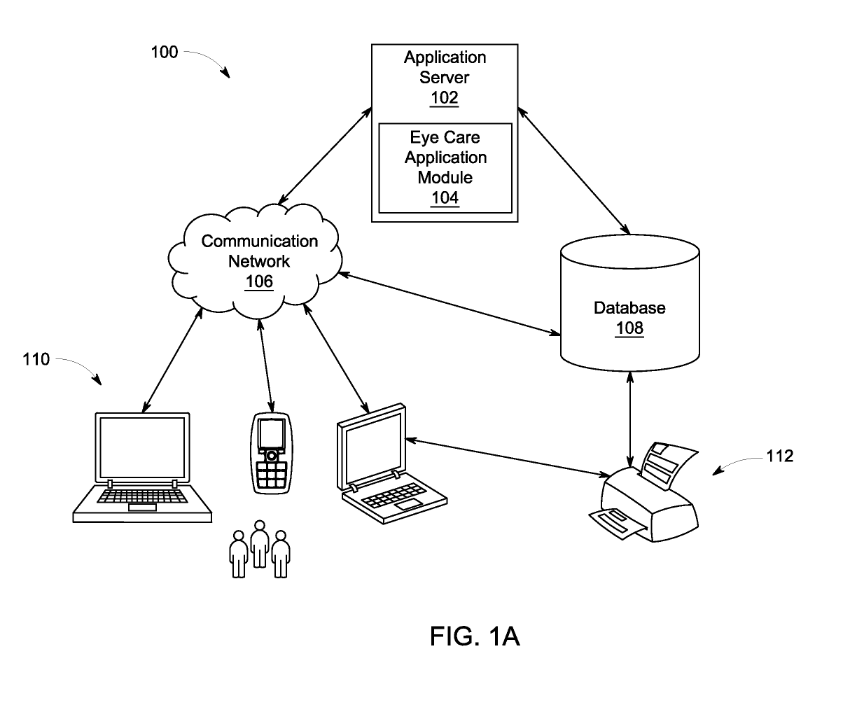

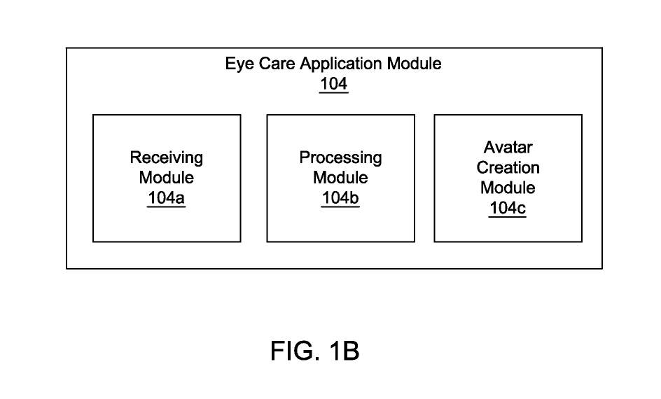

FIGS. 1a and 1b, respectively, illustrate a block diagram of the system and the eye-care application module for facilitating a user to avail eye-care services over a communication network according to one embodiment of the invention.

FIG. 1a illustrates an example block diagram of the system as per one embodiment of the present invention. The system 100 comprises an application server 102 in a communication network 106. The application server 102 comprises an eye application module 104 that allows the user including a patient, a child and parent of the child to approach an eye service provider such as an eye doctor, surgeon, ophthalmologist or an optical store or center for availing eye care services. The eye care services may include eye health examination, eye scanning and providing appropriate treatment for eye problems of the user or the patient. The user may use user devices 110 such as a communication device, phone, mobile, laptop or computer, a PDA device and a tablet or a smart phone. The system 100 may also comprise a scanning tool, such as a 2D scanner, a 3D scanner etcetera to scan the patient face, head, eyes and facial features etcetera. The scanned images along with other patient information or user data is stored on a repository 108 or a local database or on a cloud based database connected to the network 106. The communication network includes the Internet, a cloud based network, a local area network (LAN) etcetera. The user or the patient 102 can access online information using the one or more communication devices 110.

FIG. 1b illustrates a block diagram of the eye-care application module 104 for facilitating a user to avail eye-care services over a communication network according to one embodiment of the invention. In one embodiment herein, the user access the eye-care service application module 104 to record and send user data to the eye care service provider. The eye-care application module 104 comprises a receiving module 104a, a processing module 104b and an avatar creation module 104c.

The receiving module 104a receives user data including but not limiting to scanned data of head and eyes of the user. The receiving module 104a sends the user data to the processing module 104b. The processing module 104b is configured to analyze the scanned data to generate a blue print of a custom-fit eye-wear for the user. The processing module 104b is also configured to process the user data to generate the report related to eye treatment or health of the user. The report may contain details of eye related treatment and information, and also measurement of the eye-wear of the user. The report may also contain details of the user and his eye care expert for user reference. The report may further include blue print of the eye frame suitable for the user based on user preferences and analyzed user data. An avatar creation module 104c is also configured to facilitate the user to create and share one or more online avatars of the user and his/her friends connected in a social networking environment

The avatar creation module 104c may be used by the user or the child and parents and/or doctors to virtually see and fit/try on glasses. The avatar creation module 104c collects the trial and error sampling data and uses the same to develop the basic frame geometry for users. This provides a fun, stress free and personalized experience which harmonizes form and function of the custom eye wear.

Once user data has been selected via the avatar creation module 104c, the data is processed to generate the custom fit eyewear and may be further exported for 3D printing, modeling and fabrication upon user approval. The avatar creation module 104c sends information on the selected eyewear, such as dimension, color and material, to be used etcetera to an output device such as a 3D printer facility. The output device is configured to print custom eyewear based on the received information from the eye-care application module 104. The eye-care application module 104 may also be used to change the custom eyewear based on the additional information received from the eye doctor or physician and the patient via the user devices within the network 106. In one implementation, various mathematical and processing algorithms may be used to generate various options for patient eye wear. The information about such frames, their images, the cost, color options etcetera. are shared online via the internet.

The patient together with various members of social networking sites, may access such images etcetera. to make a selection of the eye-wear for the patient 102. In one embodiment, the avatar creation module 104c may create voting system for the created online avatar of the patient and his/her social network. For example, the patient may ask members of his/her social network to vote on the selection of the eyewear based on an avatar wearing such eyewear.

Thus, the system 100 facilitates in establishing the client patient (child and parent) as the center of their own eye care needs. The acquisition and transmission of 3D scanned faces and 3D solid modeling data exists in digital format, which enables the system 100 to be accessed over a communication network, and enhance user experience in the try-in and virtual manipulation of personalized decision making for the eyewear. For example, 3D computer graphics, 3D scanning and 3D printing technology may be used in support of the avatar creation module 104c, to innovate and improve the main treatment of vision disorders and blindness in children which is the proper prescription and fitting of eyeglasses. In one embodiment herein, the system also uses a patient centric digital health user interface platform, along with design based manufacture of customized eyeglasses and eye wear frames.

According to the embodiments of the present invention, the user receives health-reports from the one or more eye-care service providers based on the user data. One or more child health care service providers involved in eye-care services may also send/receive the health-reports to/from other child health care providers involved in eye-care services. A blue print of a custom-fit eye-wear for the user may be generated based on the scanned data. User may create and share one or more online avatars of the user and his/her friends connected in a social networking environment.

The custom-fit eyewear frame geometry may be generated by using the scanner for capturing a multi-dimensional scanned image of head of a user. The processing module 104b is configured to generate a uniform polygon mesh based on the scanned image. The processing module 104b also processes the polygon mesh to determine one or more landmarks on the scanned image, and align the eyewear frame geometry template with the polygon mesh. Further, based on the landmarks, the predefined measurements of the frame geometry template are altered to obtain the custom-fit eye wear frame geometry. The custom-fit eye wear frame geometry can be displayed on an output display of the user devices 110. The outputted custom-fit eye wear frame geometry can be sent or exported to 3D printing/modeling module for 3D printing and fabrication.

The database 108 is also configured to store a library of one or more eyewear frame measurements including the eyewear frame geometry template. The eyewear frame geometry template has predefined or standard measurements as explained above. The standard measurements are predefined such that it roughly fits on the scanned image. The standard measurements or the predefined measurements may be sets of different measurements for adults and children. The scanned images are obtained by the scanner that captures or scans the multi-dimensional scanned image using at least one of: 2D Scanning, 3D Scanning, 3D Model manipulation, 3D Printing and Data analysis techniques. Further, the scanner 106 is configured to use at least one of: lasers, infrared technology, visible light technologies, and CCD image sensors for capturing the scanned image of head of any user or patient.

The processing module 104b processes data from the scanned image along with other data including user data for example, vision power of the user, and other user data such as user id, name, age, user preferences, location and address of the user etcetera. Further, the processing module 104b may also process data including shapes, colors, size, and design of the frames or glasses. The display 108 facilitates a technician to visualize the geometry and scanned images of the user. The frame geometry is displayed on the display unit of the user devices 110 and landmarks on the scanned image is identified and marked. The outputted custom-fit eye wear frame geometry can be sent or exported to the 3D printing/modeling module for 3D printing and fabrication. Various printing technologies and materials may be used for 3D printing to provide durability, flexibility, scratch or damage resistance, quality lenses for the custom-fit eyewear frames.

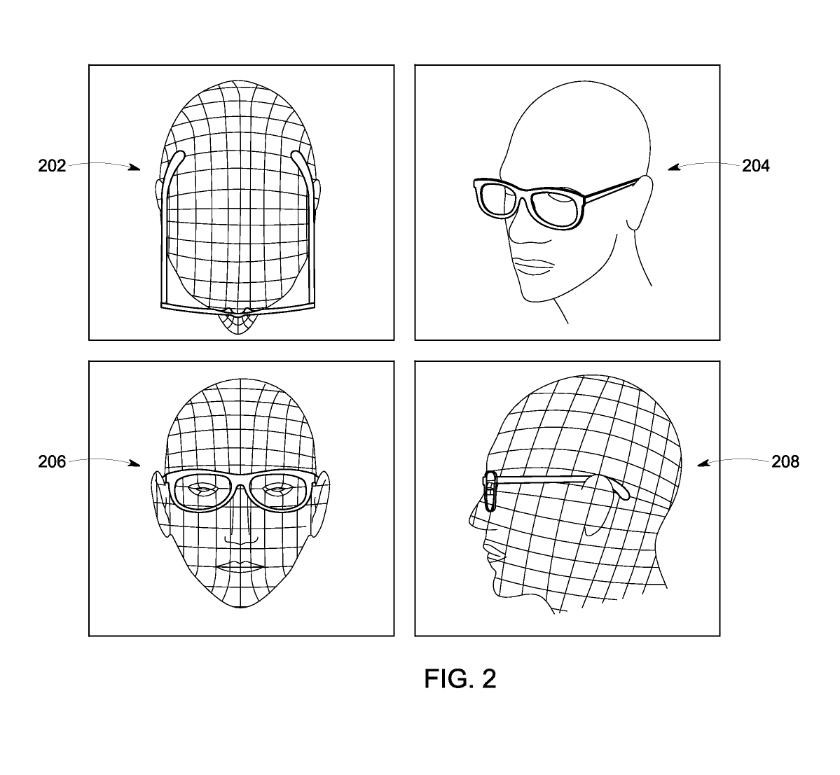

FIG. 2 illustrates scanned image 202 of head of a user and uniform polygon mesh generation 204 based on the scanned image 202 according to one embodiment of the invention. The scanned images may be obtained through active scanning or passive scanning.

In one embodiment of the present invention, active scanning is performed live wherein head of the user or the subject is scanned in real time using the scanner 106 including a deployable scanning device such as a 3D Systems Sense or Microsoft Kinect. These devices 106 may use one or combination of IR, Lasers and/or CCD image sensors to build a multidimensional image scan 202. The resulting geometry needs to be of reasonable quality to subsequently determine the necessary contact points or landmarks for making custom-fit eyewear or other personal artifacts of the user.

In one embodiment of the present invention, passive scanning is performed by using still images of the user or the subject and by using the stereo photogrammetry software. In this process the scanned image is fit to a cage mesh comprising arbitrary polygon count. A polygon mesh 204 based on the scanned image 202 of the user is thus obtained. This polygon mesh 204 may be a multidimensional mesh and have arbitrary or random polygon count which can be processed by any processor or the processing module 104b to obtain the uniform polygon mesh 204 of multi dimensions, preferably 3 dimensions. While processing the polygon mesh 204, all the redundant and undesired polygon counts are cleansed from the mesh, and thus a uniform or standardized polygon mesh 204a is obtained. Said uniform or standardized polygon mesh 204a will be later used for identifying and marking contact points or the ‘landmarks’. The cleansed mesh 204a can be introduced as a morph target. The landmarks may be designated manually or automatically on the scanned mesh 204.

Depending on the scanning method, artifacts and extraneous geometry may be present in the output geometry. In order to be ‘cleaned’ the head or target part of the user is isolated from any extra captured structures. Further, any holes appearing in the scanned image are filled by using the software or the processor. Furthermore, it has to be ensure that ear area of the scanned image is adequate to determine resting points of the eyewear frame.

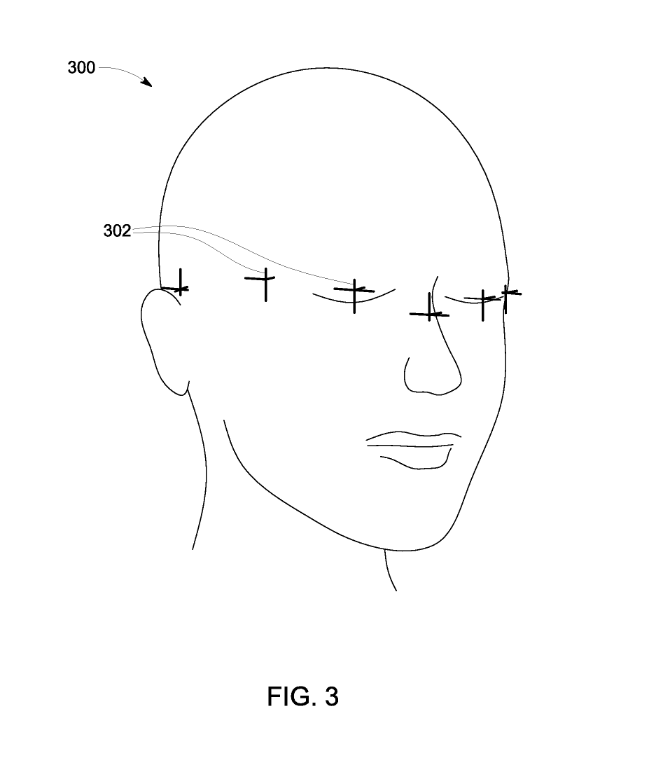

FIG. 3 illustrates landmarks 300 identification on the scanned image according to one embodiment of the invention.

The method of fitting the frame geometry template relies on specific landmarks 300 on the scanned image preferably a 3D scan to determine the necessary measurements and manipulations to perform. These contact points include the center of the bridge of the nose, the pupils of each eye, the inner folds of each ear (point where the arms of the glasses would rest), the Temporal bones or Sphenoid, Zygomatic Arch, as well as other intermediary points which can aid in aligning the template geometry.

The scanned image can be then loaded in as a morph target to an already landmark assigned geometry, to alter the polygon mesh accordingly. For a 3D scan coming from an active scanning process, the landmarks must be manually assigned to the geometry by selecting polygons or vectors. Eventually the processor of the system will be able to identify these points automatically using an algorithmic facial recognition approach.

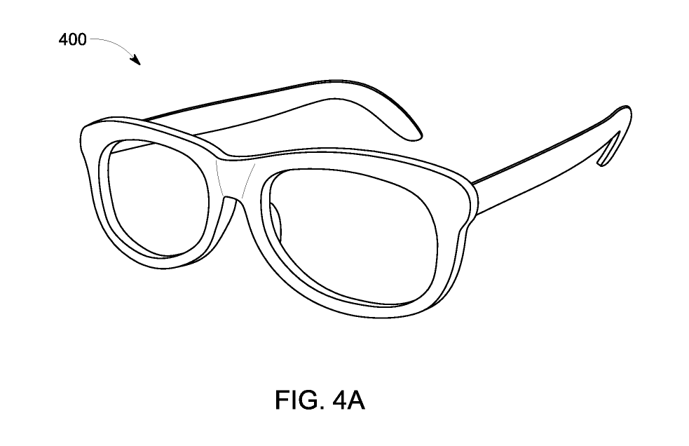

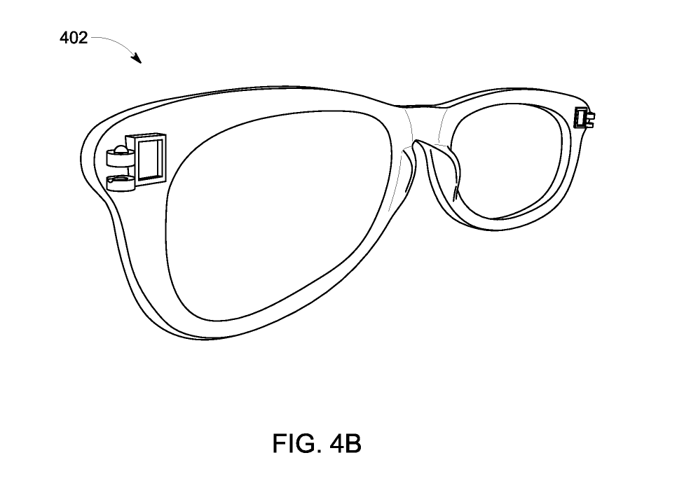

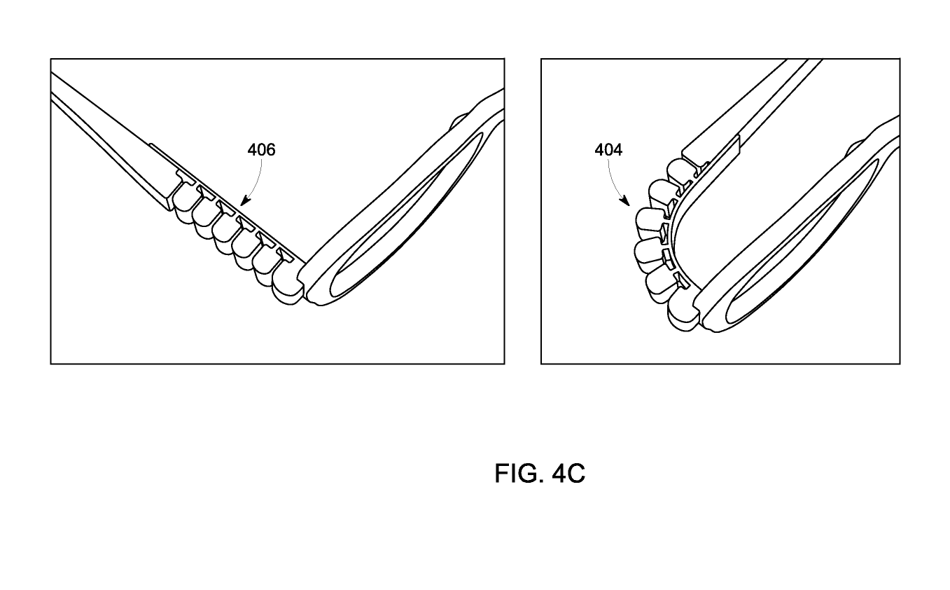

FIGS. 4A to 4C illustrate fabricated custom-fit eye wear according to one embodiment of the invention. The template geometry for all custom fit meshes is composed of individual components, each connected to each other using constraints and joint relationships. The three main components of the frame fabricated by using the generated custom-fit eye wear frame geometry are as follows; 1) a lens holder 402, 2) left temples or arms 404, and 3) right temples or arms 406.

The lens holder 402 is the front part of the frames which are responsible for holding the lenses and include the bridge and pads. The shapes of the other two components 404, 406 are changeable using morph target sliders to have it closely match the contours of the subject's nose. Additional developments may include an interchangeable nose piece so that it may be printed in different materials according to the user's comfort level.

The left and right temples or arms 404, 406 consist of the ‘ear’ pieces which are the structures which rest on the ear, as well as the hinges, which are created using a ribbed spine structure and a bend controller. The length and resting angle can be modified in order to achieve a comfortable rest position on the user's face. Respective locators are placed on the template geometry to help determine the overall alignment of the frame relative to the locators placed on the subject's scanned mesh. The template geometry is intended to be modular so that different styles can be interchanged according to the subject's comfort needs and tastes.

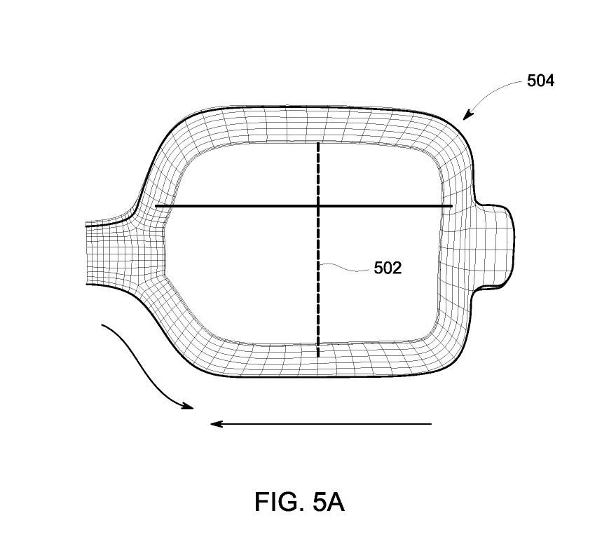

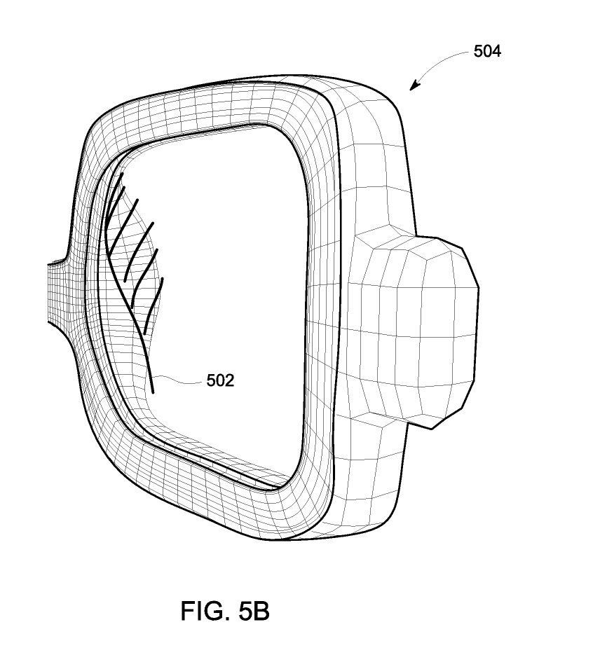

FIGS. 5A and 5B illustrate alignment and alteration of frame geometry template based on the landmarks according to one embodiment of the invention. A rough alignment of the frame geometry template 502 is first made. Once the landmarks have been applied to the scanned mesh, rough alignment can be made by rotating the scan in 3D space so that the face is aligned along the along the X, Y and Z axis respectively. This is done by checking salient points on the left and right side of the face and rotating the scan such that each pair has the same translation values along the Z axis.

Thereafter, translating and scaling the template is performed wherein the frame template is loaded in and translated into place using the ‘bridge of the nose’ locator/contact point as the main landmark. The locators on the temples and pupils are then used to determine the height and width of the frames overall. Special attention is made to the placement of the pupils relative to each lens opening. The algorithm is set to align it such that the pupils line up to the upper third of each lens opening. Once those requirements are satisfied, the template is moved on the Z axis to ensure that the proper pupil distance from the lens is achieved.

Further, arm length and angle adjustment of the frame geometry template is obtained once the lens holder has been properly aligned. The arm length is adjusted and tilted if necessary to allow the ends to rest properly around the ears.

Fine Alignment of the geometry template is obtained by using the landmarks on the bridge of the nose and the nose piece; morph targets are activated in step to change the shape of the nose piece to achieve a closer fit. A more accurate approach can be implemented using the contours of the nose on the scanned geometry as a cutting surface. This is done by treating the nose and lens holder as arguments in a ‘Boolean difference’ operation. The resulting shape of the nose piece would theoretically be the same as the contours of the nose, providing a far superior fit compared to morph target manipulation alone. Any necessary adjustments of the frame geometry can be done using a number of sliders and controls. Another approach ‘collision deformer’ may be used for fine alignment. This gives better and accurate results. In the collision deformer approach, wherever the scanned mesh and eyewear frame/glasses template intersect, the algorithm uses collision detection to “push out” vertices of the frame template geometry until it closely matches the nose profile of the scanned face.

Therefore, custom-fit eye wear frame geometry may be generated by the embodiments of the invention as described above, and may be exported for printing and fabrication. The final custom-fit eye wear frame geometry may have the arms in a closed position to save space on the print bed, as well as introduce the necessary mechanical spring tension necessary to keep the frames on the face. This is done using a bend deformer that has been rigged into the hinge structure of each arm. Each component is then joined into one mesh using nested ‘boolean union’ operations, smoothed and tesselated to meet STL 3D printing standards.

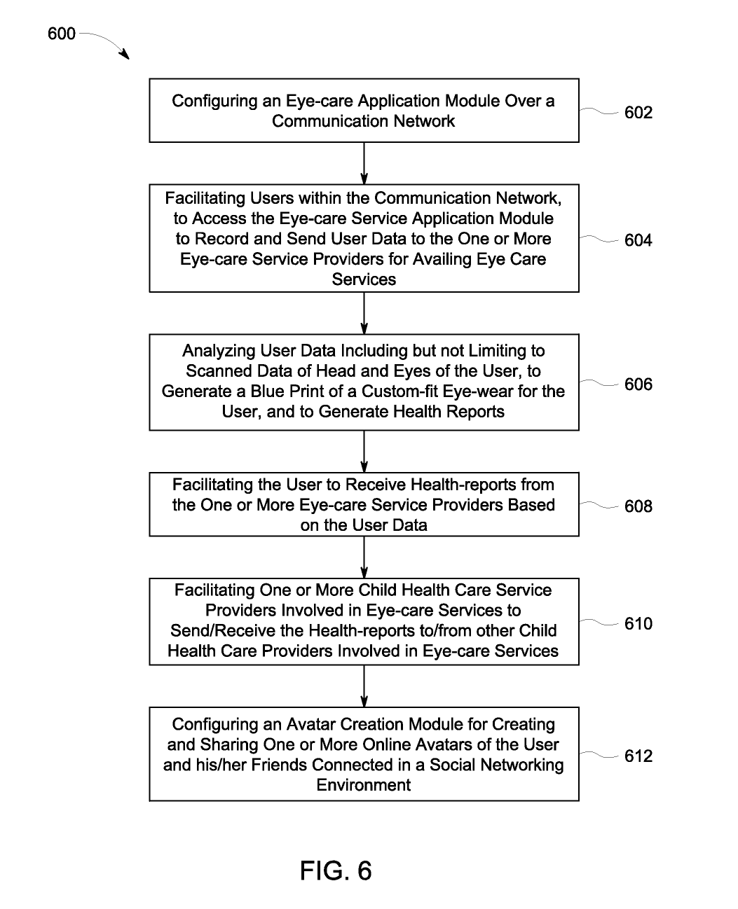

FIG. 6 is a flowchart illustrating a method for generating custom-fit eyewear frame geometry according to one embodiment of the invention. At step 602, an eye-care application module over a communication network is configured. At step 604, users are facilitated to access the eye-care service application module within the communication network, to record and send user data to the one or more eye-care service providers for availing eye care services. Thereafter, a multi-dimensional scanned image of head of a user is captured by using a scanning device or a scanner that implements laser, IR and CCD technology. The scanning may be active scanning comprising real-time scan of the subject or it may be a passive scanning wherein a still photo of the subject is used. The scanned data and other user data is analyzed to generate a blue print of a custom-fit eye-wear for the user and to generate health reports at step 606. The user data includes, but not limiting to, scanned data of head and eyes of the user according to the embodiments of the present invention.

At step 608, the user receives health-reports from the one or more eye-care service providers based on the user data. At step 610, one or more child health care service providers involved in eye-care services are facilitated to send/receive the health-reports to/from other child health care providers involved in eye-care services. An avatar creation module is configured at step 612 for creating and sharing one or more online avatars of the user and his/her friends connected in a social networking environment.

According to the embodiments of the present invention a uniform polygon mesh is generated based on the scanned image. Thereafter the polygon mesh is processed by a processor to determine one or more landmarks on the scanned image. Eyewear frame geometry template is aligned with the polygon mesh. Predefined measurements of the frame geometry template are altered based on the landmarks to obtain the custom-fit eyewear frame geometry. Finally, the custom-fit eyewear frame geometry is exported for 3D printing and modeling or fabrication.

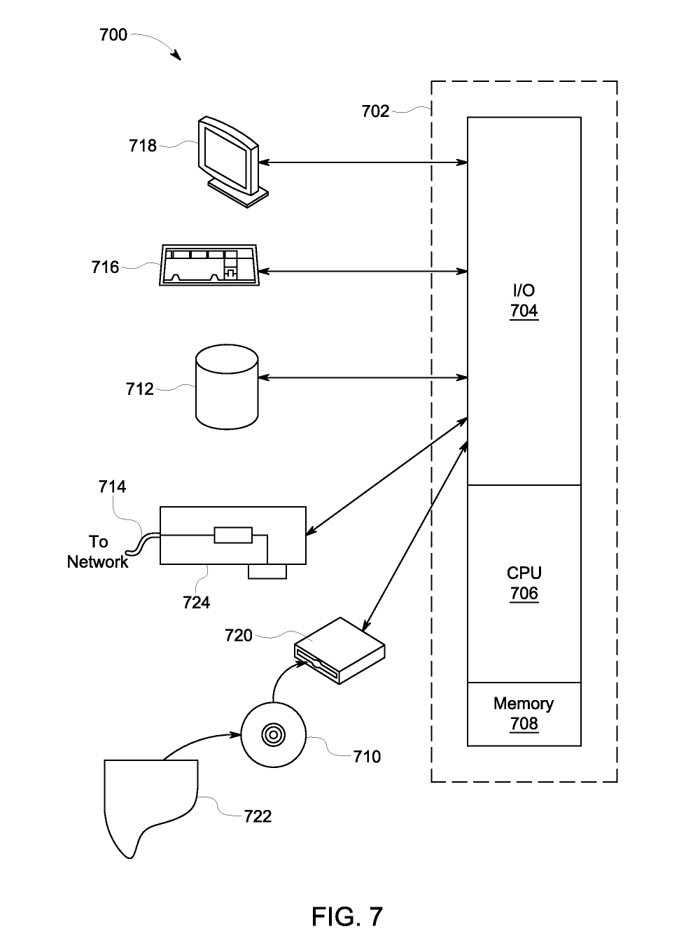

FIG. 7 illustrates an example computing system that can be used to implement the custom eyewear system disclosed herein. A general purpose computer system 700 is capable of executing a computer program product to execute a computer process. Data and program files may be input to the computer system 700, which reads the files and executes the program therein. It should be understood that computing systems may also embody devices such as Personal Digital Assistants (PDAs), mobile phones, smart phones, set top boxes, tablets, laptops and other electronic devices. Some of the elements of a general-purpose computer system 700 include a processor 702 an input/output (I/O) section 704, a central processing unit (CPU) 706, and a memory section 708. There may be one or more processors 702, such that the processor 802 of the computer system 700 comprises a single central processing unit 706, or a plurality of processing units, commonly referred to as a parallel processing environment. The computer 700 may be a conventional computer, a distributed computer or any other type of computer such as one or more external computers made available via a computing architecture. The described technology is optionally implemented in software devices loaded in memory 708, stored on a configured DVD/CD-ROM medium 710 or storage unit 712, and/or communicated via a wired or wireless network link 714 on a carrier signal, thereby transforming the computer system 700 to a special purpose machine for implementing the described operations.

The I/O section 704 is connected to one or more user-interface devices (e.g., a keyboard 716 and a display unit 718), a disk storage unit 712, and a disk drive unit 720. Generally, in contemporary systems, the disk drive unit 720 is a DVD/CD-ROM unit capable of reading the DVD/CD-ROM medium 710, which typically contains program and data 722. Computer program products containing mechanisms to effectuate the systems and methods in accordance with the described technology may reside in the memory section 704, on a disk storage unit 712, or the DVD/CD-ROM medium 710 of such a system 700, or external storage devices made available via a cloud computing architecture with super computer program products including one or more database management products, web server products, application server products and other software components. The network adapter 724 is capable of connecting the computer system to a network via the link 714, through which the computer system can receive instructions and data.

Implementations of the disclosed invention are thus obtained within hardware and software that allows one to capture a 3-dimensional scan of a user's/child's head virtually fit the child with custom eyeglasses and then output the 3-D digital mold of the eyeglasses, to a 3-D printer. As a result, the child attains wearable prescription glasses that are custom made to measure and produced by the process of additive manufacturing. Various printing technologies and materials may be used for 3D printing to provide durability, flexibility, scratch or damage resistance, quality lenses for the custom-fit eyewear frames.

An implementation of the system is portable and affordable, so that a doctor could if needed manufacture eyeglasses while the patient waits. An alternative implementation allows printing clear optical grade prescription lenses as an integrated component of the eyeglasses frame. Yet alternative implementation uses non-additive fabrication techniques that optimize and improve the fit, function and cosmetic of child and adult eyeglasses.

Various implementations of the system disclosed herein provide various benefits listed below:

1. optimized, customized and unique fit of eyeglasses to an individual's face, resulting in improved medical or optical treatment of visual disorders and improved visual function.

2. streamline designed manufacture and distribution of eyeglasses affording improved availability to children and their families.

3. improved user experience in the selection (try-in), design and delivery of eyeglasses.

4. alignment of utility value of glasses design, manufacture and wear with the convergent trends of a) increased patient engagement with their health system and providers, b) internet technology that can be a suitable platform to channel this interactive engagement and c) accountable care act (ACA) and health information technology for economic and clinical health (HITECH) framework legislation that codify and incentivize improved care co-ordination patient satisfaction and health care outcomes for health care providers.

While the system and methods disclosed herein are discussed in view of custom eyewear, it can also be used for other customer wear, such as helmets, hearing devices, headphones, etc. thus, 3D scan of a patient's ears may be used to generate 3D printing blue prints and used to generating hearing aids.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems and various embodiments described herein can be combined to provide further embodiments. These and other changes can be made to the invention in light of the detailed description.

These and other changes can be made to the invention in light of the above detailed description. In general, the terms used in the following claims, should not be construed to limit the invention to the specific embodiments disclosed in the specification, unless the above detailed description explicitly defines such terms. Accordingly, the actual scope of the invention encompasses the disclosed embodiments and all equivalent ways of practicing or implementing the invention under the claims.

While certain aspects of the invention are presented below in certain claim forms, the inventors contemplate the various aspects of the invention in any number of claim forms. Accordingly, the inventors reserve the right to add additional claims after filing the application to pursue such additional claim forms for other aspects of the invention.

What is claimed is:

1. A system for facilitating a user to avail eye-care services from one or more eye-care service providers over a communication network, the system comprising:
an application server for storing an eye-care service application module;
one or more communication devices, each having a web-based user interface configured to:
facilitate the user to access the eye-care service application module to record and send user data to the one or more eye-care service providers,
facilitate the user to receive health-reports from the one or more eye-care service providers based on the user data, and
facilitate one or more child health care service providers involved in eye-care services to send/receive the health-reports to/from other child health care providers involved in eye-care services;
a repository/database configured to securely store the user data and the health-reports;
wherein the eye-care application module comprises:
a receiving module configured to obtain the user data including but not limiting to scanned data of head and eyes of the user;
a processing module configured to: (i) analyze the scanned data to generate a blue print of a custom-fit eye-wear for the user, and (ii) process the user data to generate the report;
an avatar creation module configured to facilitate the user to create and share one or more online avatars of the user and his/her friends connected in a social networking environment.

2. The system of claim 1, wherein the user is a child and/or an adult.

3. The system of claim 1, wherein the user data further includes vision measurements of the user and virtual trial-fits data that are processed to develop the blue print of the custom-fit eyewear for the user.

4. The system of claim 3, wherein the trial-fits data are recorded by the user and/or the eye-care service providers by taking virtual trials of the eyewear while accessing the eye-care application module.

5. The system of claim 1, wherein the eye-care application module is further configured to provide various mathematical and processing algorithms to generate a plurality of options for the custom-fit eyewear.

6. The system of claim 5, wherein the options include cost, color, design, lens type, and manufacturing materials of the custom-fit eyewear for selection and preferences of the user.

7. The system of claim 1, wherein the blue print is outputted for 3D printing, modeling and fabrication of the custom-fit eyewear.

8. A method for facilitating a user to avail eye-care services from one or more eye-care service providers over a communication network, the method comprising the steps of:
configuring one or more communication devices, each having a web-based user interface for:
facilitating the user to access eye-care service application module to record and send user data to the one or more eye-care service providers,
facilitating the user to receive health-reports from the one or more eye-care service providers based on the user data, and
facilitating one or more child health care service providers involved in eye-care services to send/receive the health-reports to/from other child health care providers involved in eye-care services;
securely storing in a repository/database the user data and the health-reports;
storing and configuring the eye-care application module in an application server to:
obtain the user data including but not limiting to scanned data of head and eyes of the user,
analyze the scanned data to generate a blue print of a custom-fit eye-wear for the user, and
process the user data to generate the report;
configuring an avatar creation module for creating and sharing one or more online avatars of the user and his/her friends connected in a social networking environment.

9. The method of claim 8, wherein the user is a child and/or an adult.

10. The method of claim 8, wherein the user data further includes vision measurements of the user and virtual trial-fits data that are processed to develop the blue print of the custom-fit eyewear for the user.

11. The method of claim 10, wherein the trial-fits data are recorded by the user and/or the eye-care service providers by taking virtual trials of the eyewear while accessing the eye-care application module.

12. The method of claim 8, wherein the eye-care application module is further configured to provide various mathematical and processing algorithms to generate a plurality of options for the custom-fit eyewear.

13. The method of claim 12, wherein the options include cost, color, design, lens type, and manufacturing materials of the custom-fit eyewear for selection and preferences of the user.

14. The method of claim 8, wherein the blue print is outputted for 3D printing, modeling and fabrication of the custom-fit eyewear.
